(19) United States
(12) Patent Application Publication
(10) Pub. No.: US 2015/0192283 A1
(43) Pub. Date: Jul. 9, 2015

(54) LED Light Has Electric Coil-Means and Magnetic-Means

(71) Applicant: Tseng-Lu Chien, Walnut, CA (US)

(72) Inventor: Tseng-Lu Chien, Walnut, CA (US)

(21) Appl. No.: 14/149,092

(22) Filed: Jan. 7, 2014

(51) Int. Cl. F21V 23/02; F21V 33/00

(52) U.S. Cl. CPC F21V 23/02; F21V 33/0052; F21V 33/0056; F21W 2131/30

(57) ABSTRACT

An LED light device has at least one electric coil-means and at least one of related magnetic-means build-in on movable pendent to get the desire functions in group of combination from (1) device body, housing has moving, waving, shaking function with at least one of the parts, body, housing be illuminated or (2) The device has project a moving, waving, shaking, vibration LED light image on the non-moving surface (3) The device has more than one functions while optional add other electric device function within the said body or housing to become multiple functions LED light device from market available devices for toy item, character item, game item, decorative item, gift item, give-away item, commercial items, advertisement items, promotional items, slogan, sign, art related items, child items, or consumer electric products, computer products, communication products or any products available from market place.

### BACKGROUND OF THE INVENTION

The U.S. prior art U.S. Pat. No. 8,070,319 and its parent filing date on Sep. 30, 2008 which are later than the co-inventor's issued patent U.S. Pat. No. 7,832,917 filing date on Sep. 18, 2008 which is 12 days earlier than the U.S. Pat. No. 8,070,319 and also the U.S. Pat. No. 7,832,917 is CIp filing of the co-inventor's Mar. 30, 2005 filed.so the prior art of U.S. Pat. No. 8,070,319 for any light project to moving display unit is not as valid Patent in front of the co-inventor parent filing patent.

From U.S. Pat. No. 8,080,319 to make a moving display paper or plastic piece as surface to let the LED light beam lighted, This is not has the Moving Pendent has built-in Optics lens like the current invention teach below.

The current invention apply the Optics-lens built-in moving pendent to allow the FIXED LED light beam passing though moving optics-lens because the LED light beam input to the different position of optics-lens so has the light beam amount changed, light input angle changed, light beam into different cross-section optics-lens, Light beams emit into different thickness of the lens while optics-lens moving so the said image of the said LED light source will has a variety very nice and nature like the Candle in the wind.

The prior art to make the LED light beam to hit the moving paper or Plastic piece like use gun to shoot the moving target . . . . So the LED light beams will be hit the target or fall outside the moving target. This is main features and look very bad light effects for difficult so the current invention to show the image on non-movable surface and which is Big and Wide so no any missing project to Outside of surface.

The current invention are CIP of co-inventor's co-pending filing or following projection light device including:

1. (#XX-10)=(Ser. No. 12/938,564) Nov. 4, 2010 Laser project

2. (#AAA-10) Ser. No. 12/948,953 Time projector—Nov. 13, 2010

3. (#EEE-11) Ser. No. 13/021,107—3D projection=Feb. 4, 2010

4. (#QQQ-12) Ser. No. 13/549,728=LED bulb projection

5. (#XXX-13) Ser. No. 14/024,229 LED kaleidoscope II—Sep. 10, 2013

6. (#ZZZ-13) Ser. No. 14/023,889 Multiple reflectors projection—Sep. 10, 2013

7. (#AAAA-13) Ser. No. 14/019,779 Water projection Sep. 4, 2013

8. (#BBB-13) Ser. No. 14/030,023 Motor projection without liquid—Sep. 15, 2013

U.S. Ser. No. (14/030/023) LED Light has motor means and project image (#BBBB) Filed on Sep. 15, 2013.

U.S. Ser. No. (14/019,779) Multiple function LED project Light has built-In Motor means, (#AAAA) Filed on Sep. 5, 2013

U.S. Ser. No. (14/023,889) LED light has more than one reflective means to project Light or image, (#ZZZ) Filed on Sep. 10, 2013.

U.S. Ser. No (14/024,229) LED light has kaleidoscope means to project image, (#XXX) Filed on Sep. 10, 2013.

U.S. Ser. No. 13/021,124 LED light has changeable image and pattern by kaleidoscope means to project to surfaces. (#WWW) Filed on Feb. 4, 2011 and public on Aug. 9, 2012, 2012-0200-828.

U.S. Ser. No. 12/710,918 LED light has more than one reflector means, Now U.S. Pat. No. 8,8277,087 which similar with current invention to apply the kaleidoscope means which has more than one reflective means hereof use mirror or mirror-like means to assembly into kaleidoscope means.

U.S. Ser. No. 11/806,284 LED light has more than one optic means, now U.S. Pat. No. 7,632,004 which has use more than one optics means which similar with current invention to apply the optics means in front of or back of the light means to create, adjust, magnify, reduce, enlarge the said the said image, LEDs light beams, LED lights' image, shape which including the any combination from optics lens, optics mirror, laser hologram, laser grating film, optics assembly

U.S. Pat. No. 7,455,444 LED light has more than one LED light source, the current invention use more than one LEDs for matrix arrangements with Circuit means, IC means, sensor means, switch means, brightness control means, color mix means, color selection means, color freeze means, motor means, gear means, turn-On and turn-Off means to make the certain number of LEDs turn-On with desired color, brightness, light brightness output, light functions, matrix combinations, motor means, rotating means, gear set means to pass though the said kaleidoscope means, optics means, laser mans, motor means, gear means, to has desired light patterns.

U.S. Ser. No. 12/948,953, U.S. Ser. No. 12/938,564 U.S. Ser. No. 12/886,832, U.S. Ser. No. 12/876,507, U.S. Ser. No. 12/771,003, U.S. Ser. No. 12/624,621, U.S. Ser. No. 12/914,584, U.S. Ser. No. 12/318,471, U.S. Ser. No. 12/318,470, U.S. Ser. No. 12/834,435 and also is continuous filing for co-inventor's prior filing cases as below issued patents:

U.S. Ser. No. 12/292,153 (now is U.S. Pat. No. 7,871,192),

U.S. Ser. No. 12/232,505 (now is U.S. Pat. No. 7,832,917),

U.S. Ser. No. 12/318,473 (now is U.S. Pat. No. 7,832,918).LED light has laser means

U.S. Ser. No. 12/624,621 (Now is U.S. Pat. No. 8,303,150) LED project light for Seasonal items

U.S. Ser. No. 12/771,003 (now is U.S. Pat. No. 8,408,736) Light device has More than one project means.

U.S. Ser. No. 12/876,507 (now U.S. Pat. No. 8,083,377) Light device has projection function with focus adjustable and project means can change position

U.S. Ser. No. 12/886,832 Digital data projection Light device, Sep. 8, 2010 filed

U.S. Ser. No 12/938,564 Laser projection light device, Nov. 4, 2010 filed

U.S. Ser. No. 12/948,953 LED light has time projection. Nov. 13, 2010 filed.

U.S. Ser. No. 13/021,107 LED light has 3Dimensional projection, Feb. 4, 2011 filed.

Above listed Projection light device total has (9) projection light device are parent filing cases as CIP filing of the current invention.

Further more the Co-invention also has co-pending filing for light device has interchangeable power source for Wall outlets AC power and Energy storage means (Direct current) including the all kind of combination selection from prong mean, extension cord, adaptor, transformer, Solar, wind power, Batteries, chemical power, biologic power all can be interchange or for for any AC or battery power for Desk Top and Plug In type of current invention of project light device has build-in kaleidoscope means. The interchangeable co-filing cases as below:

U.S. Ser. No. 12/318,473,

U.S. Ser. No. 12/940,255 (Now U.S. Pat. No 8,231,246) #FF-1

So the current invention are CIP for variety of co-inventor's co-pending or co-patents as above listed including: (1) Project light device (2) More than 1 optics means (3) More than 1 LEDs (4) More than 1 reflective means (5) Interchangeable power source (6) Laser Means (7) Adjustable focus and position changeable (8) motor & Gear set for moving adjustable.

This application has subject matter in common with U.S. patent application Ser. Nos. 12/710,561; 12/711,456; 12/771,003; 12/624,621; 12/622,100; 12/318,471; 12/318,470; 12/318,473; 12/292,153; 12/232,505; 12/232,035; 12/149,963; 12/149,964; 12/073,095; 12/073,889; 12/007,076; 12/003,691; 12/003,809; 11/806,711; 11/806,285; 11/806,284; 11/566,322; 11/527,628; 11/527,629; 11/498,874; 12/545,992; 12/806,711; 12/806,285; 12/806,284; 12/566,322; 12/527,628; 12/527,629; 12/527,631; 12/502,661; 11/498,881; 11/255,981; 11/184,771; 11/152,063; 11/094,215; 11/092,742; 11/092,741; 11/094,156. 11/094,155. 10/954,189; 10/902,123, 10/883,719; 10/883,747; 10/341,519; 12/545,992; and 12/292,580.

In particular, the following applications show light devices that have at least some features in common with included or optional features of the LED light device of the present invention: Ser. No. 12/710,561 (“LED power failure Light”); Ser. No. 12/711,456 (“LED light device has special effects”); Ser. No. 12/771,003 (“LED light device has more than 1 reflective means for plurality of image”); Ser. No. 12/624,621 (“projection device or assembly for variety of LED light”); Ser. No. 12/622,000 (“Interchangeable Universal Kits for all LED light”); Ser. No. 12/318,471 (“LED night light with pinhole imaging”); Ser. No. 12/318,470 (“LED night light with Projection features”); Ser. No. 12/318,473 (“LED night light with laser or hologram element”); Ser. No. 12/292,153 (“LED night light with Projection or imaging features”); Ser. No. 12/232,505 (“LED night light with Projection features”); Ser. No. 12/149,963 (“Removable LED light device”); Ser. No. 12/149,964 (“Surface Mounted Device with LED light”); Ser. No. 12/073,095 (“LED Track light device”); Ser. No. 12/073,889 (“LED light with changeable position with Preferable power source”); Ser. No. 12/007,076 (“LED light with changeable geometric system”); Ser. No. 12/003,691 (“LED light with changeable geometric dimension features”); Ser. No. 12/003,809 (“LED light with changeable features”); Ser. No. 11/806,711 (“Multiple LED light with adjustable angle features”); Ser. No. 11/806,285 (“LED Night light with outlet device”); Ser. No. 11/806,284 (“LED Night light with more than 1 optics means”); Ser. No. 11/527,628 (“Multiple function Night light with air freshener”); Ser. No. 11/527,629 (“LED Night light with interchangeable display unit”); Ser. No. 11/498,874 (“Area illumination Night light”); Ser. No. 11/527,631 (“LED Time piece night light”); Ser. No. 12/545,992 (“LED time piece Night light”); Ser. No. 12/292,580 (“LED Time Piece Night light”); Ser. No. 11/498,881 (“Poly Night light”); Ser. No. 11/255,981 (“Multiple light source Night Light”); Ser. No. 11/184,771 (“Light Device with EL elements”); Ser. No. 11/152,063 (“Outlet adaptor with EL”); Ser. No. 11/094,215 (“LED night light with liquid medium”); Ser. No. 11/094,215 (“LED Night light with Liquid optics medium”); Ser. No. 11/092,741 (“Night light with fiber optics”); Ser. No. 10/883,747 (“Fiber Optic light kits for footwear”); Ser. No. 11/498,874 (“Area Illumination for LED night light”); Ser. No. 11/527,629 (“Time Piece with LED night light”); Ser. No. 11/527,628 (“Multiple Function Night light with Air Freshener”); Ser. No. 11/806,284 (“LED Night light with more than one optics mediums”); Ser. No. 11/806,285 (“LED Night Light with multiple function”); and Ser. No. 11/806,711 (“Multiple LEDs Light with adjustable angle function”).

The applications of the inventor in general all apply physics or optics theory to LED light supplied with power from an outlet, battery, solar, or other power source. The present invention uses the physics or optics theory to create at least one of LED light MOVING, Waving, Shaking, Vibration images on a non-moving surface or moving, shaking, waving, vibration LED light body or housing or parts. More specifically, the current invention uses at least one optics means, optics means, LED light means incorporate with electric coil means and magnetic means to project the said at least one of LED spot light into a Moving flame images or make the said LED light body or housing or parts has moving effects to be seen by viewer. The principles of the invention may be applied to any kind of LED lights of various types, including LED lights disclosed in the above-listed patents and patent applications of the inventor, which may be powered by a variety of power sources, such as an outlet, batteries, solar, wind, or chemical power sources.

Further cost saving can be achieved in the case of a battery powered unit by using a circuit with proper electric components, parts, and accessories to raise the voltage output of the batteries to trigger the LED or LEDs even though the number of batteries is less than that normally required to generate the required voltage. This can counter the tendency of people to use a large quantity of batteries and save substantial cost, which is another important advantage of the current invention.

In this embodiment, a plurality of the LED beam can be project outside though the said non-moving surface(s).

The LED or LEDs of the current invention are preferably connected with circuit means, power means, contact means, electric coil-means, magnetic means, conductive means, switch means, sensor means, motor means, spin means, rotating means, gear set means, speed control means, printed circuit means, blue tooth means, remote control means, infra-red means, internet means, wifi means, or integrated circuit (I.C.) means and/or related parts and accessories to cause the LED or LEDs to turn on and off according to a predetermined time period, functions, colors, and/or effects to provide a desired lighting performance.

The LED or LEDs can be selected from any combination of single color, multiple color, multiple piece, standard, and special LED assemblies, LED number from 1 to N (N can be any number) to arrange in desire matrix spacing which available on the market.

Finally, the distance, position, orientation of the re optical-means may be changed basing on the selected geometric shape of optics means. The LED or LEDs arrangement for different of LED number, position, color, IC chip, control means, circuit means, functions, and brightness can create a desire at least one of moving light patterns, moving housing, moving body, moving parts, show, color changing, images changing, moving effects to people to be seen on surrounding non-moving surface(s) including walls, ceiling, floor, or desire surface(s).

The said geometric optics means can has any shape with multiple construction and the said the geometric optics means has desire combination selected from the passing though lens, reflective lens, convex lens, concave lens, laser lens, hologram lens on the inner or outside surface or all side of the surface to make certain light effects.

According to another preferred embodiment of the invention, an LED light device having power saving features includes at least one LED or LEDs for a light source, at least one housing having space to install circuit means, conductive means, electric components parts and accessories, switch means, sensor means, an integrated circuit (IC), and/or a micro controller to connect with a conventional market-available power source to cause the LED or LEDs to turn on and turn to provide predetermined functions or effects, with a predetermined duty cycle, color, and/or brightness.

The power-saving features are obtained by using the control means to cause the LED or LEDs turn-on for only a certain percentage of each cycle. In particular, the turn on time is selected to meet the persistence of vision of the human eye, so as to take advantage of the human eye's response time of 1/24 to 1/16 second so that the blinking LED or LEDs looks as if it were continuously on.

According to yet another embodiment of the invention, an LED light device having cost saving features includes at least one LED or LEDs as a light source, at least one housing having space to install circuit means, conductive means, electric components parts and accessories, switch means, sensor means, an integrated circuit (IC), and/or a micro controller to connect with a conventional market-available power source, preferably batteries, to cause the LED or LEDs to turn on and turn off according to a predetermined function or effects, duty cycle, color, and/or brightness.

In this embodiment, cost saving is obtained by providing batteries having a total voltage that is less than the LED trigger voltage and by providing electric components and related parts and accessories to increase the voltage output of the batteries to greater than the LED trigger voltage.

As noted above, the current invention uses at least one of electric coil-means and related magnetic means or selected optics-means has built-in at least one of LED light means to create a plurality of LED light beam passing though moving optics means while the electric coil-means and magnetic means reaction to each other.

The relative distance, position, and/or orientation of the electric coil-means and at least one of related magnetic means can make the best moving, waving, shake, vibration of the said pendent means to make the attached on the display unit or the optic means to moving to incorporated LED light means to crease moving LED image or make the said LED light housing or Body or parts to move, wave, shake, vibration.

### BRIEF DESCRIPTION OF THE DRAWINGS

FIGS. 1 and 1A: shows a first preferred embodiment of the current invention has coil-means and magnetic means to activate each other to make the pendent moving and cause the build-in Optics lens moving too and make the LED light means light beams passing though the Moving optics-lens to project the moving flame like image to the LED light non-movable surface such as housing. It also disclosure the interchangeable power source, USB wire or other power source for the current invention. a first preferred embodiment of the current invention in the form of LED Candle or LED candle sets preferred use the DC power-means or USB Power or inter-changeable power source, it also can use prong means to work with AC power source. The other application can incorporate with additional LED light means inside the housing to make the whole body glows under predetermined functions, performance by circuit and control means.

FIGS. 2, 2A, and 2B show a first preferred embodiment of the current invention has AC power-means or other power source for Wall Plug-in or DeskTop or hanging window application of current invention has at least one of electric coil-means and related number of magnetic means has optional optics-means to cause at least one of the LED light emit out light beam to the said moving optic-means or emit to the housing or body of the said LED light. One of current invention to project the LED light images to be seen on non-movable surface by a viewer. Another function to has additional LED light means to make the moving LED light housing, Body, parts to be glows under predetermined function. It also teach the variety of added functions may fit within the spacing for the LED light because under the LEDs has plenty of space to add more added functions from electric device, digital device, communication device, computer device, consumer electric device categories. From FIGS. 2-1) and (2-2) and FIG. 7) also show the details parts name and comparison drawing for different viewing angle of 1^{st} embodiment.

FIGS. 3 and 3A-3C: shows all different light image project on the non-movable surface of 1^{st} Embodiment which are created by moving pendent which has the build-in magnetic means to activate with build-in electric coil-means so pendent moving and make the build-in Optics means moving so fixed position at least one LED light beam passing though the different position, orientation, angle, cross section of the said optics-lens so the LED light beams image has different size, position, orientation, brightness look like candle in the wind effects.

FIGS. 4A-4D show the 1^{st} preferred embodiment's inner electric coil-means and related magnetic means reaction for different position while the input current to the electric coil-means changed, the relation of the electric coil-means and magnetic means distance changed so moving pendent change position accordingly to make the Optics-lens change position so the image project out by the Optics-lens also changed and moving, waving, swing, vibration.

FIGS. 5A-5C show the 1^{st} embodiment outside shape and inner construction relations while the moving pendent change position the project out image will also be changed for size, position, brightness, color because the LED light beams passing though the moving pendent build-in optics lens for different light in-put angle, amount of light beams so will make different project image on the non-movable surface.

Furthermore, the FIG. 5C shows all preferable power source(s) for the current inventions.

FIGS. 6A and 6B show the details image passing though the moving optics lens which are built-in on the pendent means where at least one of magnetic-means are built-in On the end of the pendent. While the pendent's magnetic-means reactive with housing electric coil-means will make pendent moving, so the optics lens moving too and make the project out light beams also changeable for size, position, color, orientation . . . etc.

From FIG. 7 same as FIGS. 2A and 2B shown all parts and accessories name.

FIGS. 8A-8C show more details and more further application while add other parts & accessories can make more eye-catching functions, performance, effects.

FIGS. 9A-9C show the 2^{nd} embodiment has the moving, waving, shaking, vibration LED light in a character products which is lighted by the inner at least one of the LED light means and has built-in electric coil-means and magnetic means reaction so make the pendent and related arms, frame, post, joint-means, adjacent piece, plastic piece, rod, support and related parts & accessories moving together to make at least parts or body or whole products or LED light to moving while the input current of the said electric coil-means changed.

The said LED light in a character products which may be in any geometric shape and it also can be any products available from market place from non-movable become moving products. It can be toy item, character item, game item, decorative item, gift item, give-away item, commercial items, advertisement items, promotional items, slogan, sign, Infant related items, child items, or consumer electric products, computer products, communication products or any products available from market place has the build-in Electric coil-means and at least one of magnetic means with at least one of LED light means to make the Light projection or Lighted the products, unit, body or housing or parts.

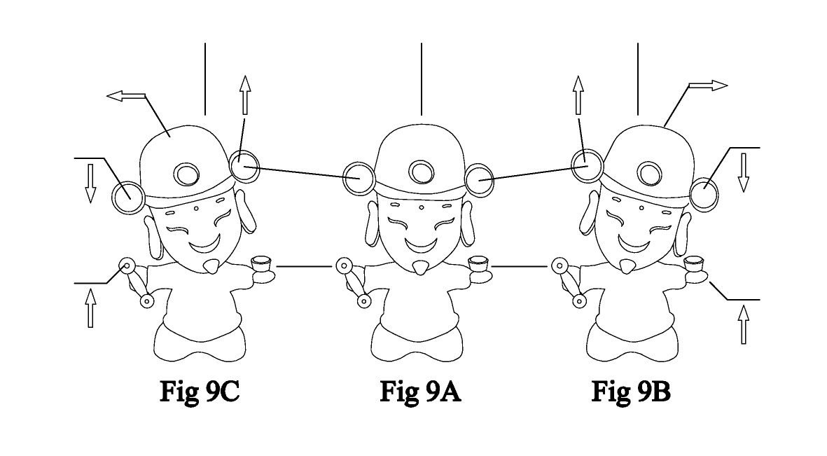

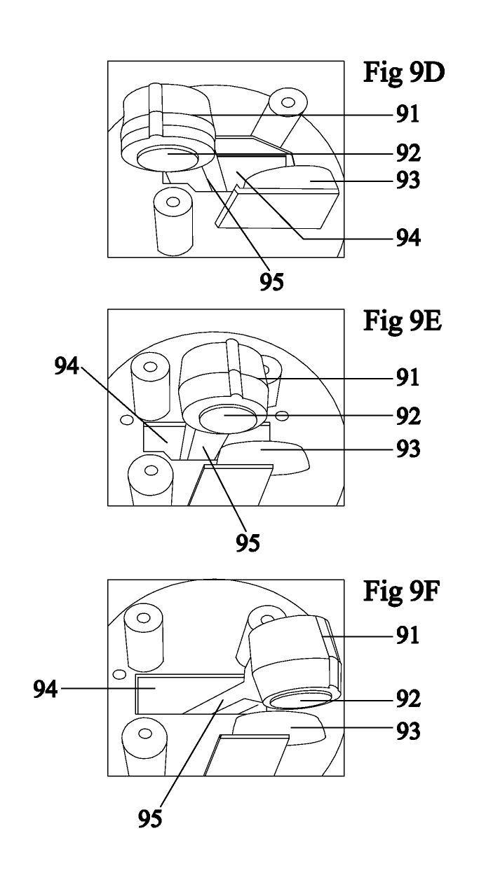

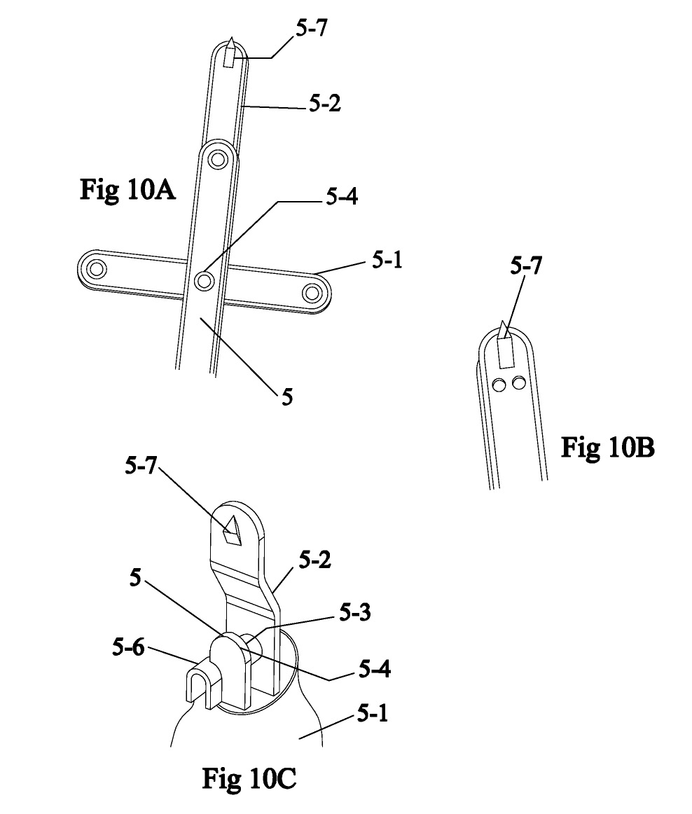

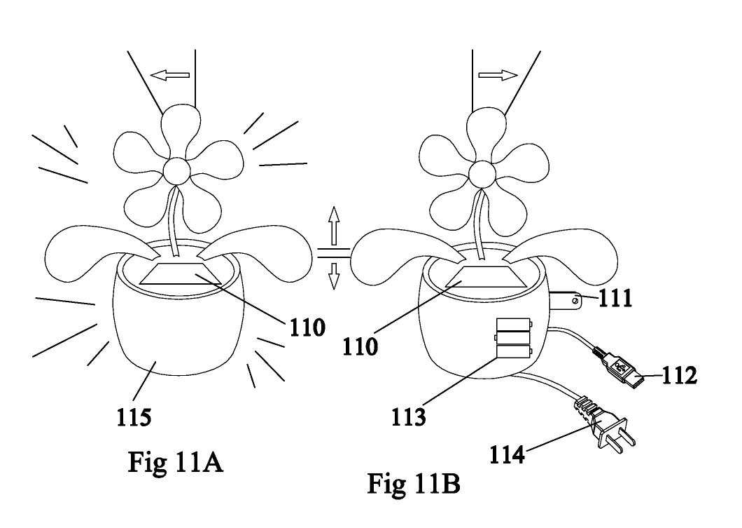

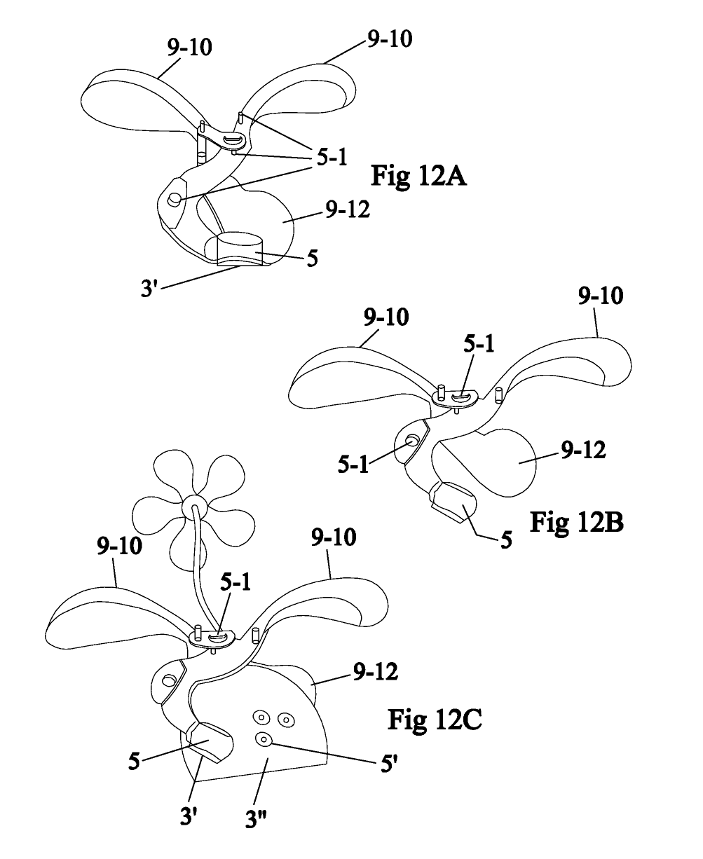

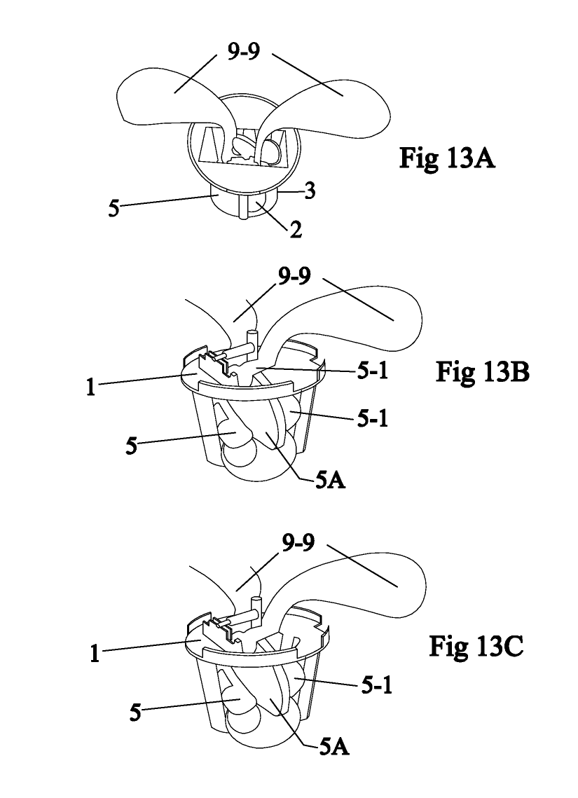

FIGS. 9D-9F show the position of the moving pendent which are basing on the reaction of the electric coil-means and at least one of magnetic-means.

FIGS. 10A-10C the one of embodiment how to make the multiple parts, body, housing to move together with the moving pendent which are moved by the reaction of the at least one of magnetic-means been activated by the electric coil-means while the said electric coil-means been changed the input current.

The sharp tip with the most few contact area with the moving display unit will make the moving more sensitivity and smoothly. If too big will get big resistance by friction between the contact-surface. It also has the plurality of joint-means in variety form to make the each separated or district pieces to work together by mechanical theory.

FIGS. 11A and 11B show the 2^{nd} preferred embodiment is plants and flower on the vase which still belong to the LED light device in the form of market available products which has the Moving flower and leafs. It may power by any desire group combination of the selection from solar power, prong means to get AC power, Battery to get DC power, USB Cable to get AC or DC power, Or other power source, wind power, chemical power, water power, any Energy storage power source or from market available power source.

FIGS. 12A-12C show the 2^{nd} preferred embodiment's for pendent and its related parts & accessories to make at least one of the Parts, Body, Housing, unit, products has plurality of parts moving by the said pendent, frame, support, bar, post, injection piece(s), joint means, fix means, hold means, fasten means, sharp tip means, range limited means, connect means and its related at least one of the said magnetic-means reaction with the said electric coil-means and related housing or body's install means.

FIGS. 13A-13C show the details construction of the said all moving parts, Body, Housing, unit, products has plurality of parts moving by the said pendent, frame, support, bar, post, injection piece(s), joint means, fix means, hold means, fasten means, sharp tip means, range limited means, connect means and its related at least one of the said magnetic-means reaction with the said electric coil-means and related housing or body's install means. The details shown the said electric coil-means and at least one of the said magnetic-means to make more than one of parts, body, housing to moving smoothly with build-in more than one LED means or additional LED or light means to make the whole body glows or add the additional market available functions selected from market all lighting functions, performance, effects.

### DETAILED DESCRIPTION OF THE PREFERRED EMBODIMENTS

The current invention has following features and also has all co-inventor's prior arts and co-pending and co-issued patents as below descriptions:

1 An LED light device has coil-means and magnetic-means comprising:
At least one LED arranged as a light source to supply visible light beams;
At least one of the electric coil-means which will create the magnetic-field while electric current passing though the coil's conductive wire.
At least one or more than one of the magnetic-means has desire combination from group combination select from magnetic(s), electric coil(s), magnetic activated-means(s), pendant-mean, frame(s), arms, supports, connector(s), joint-piece, holder(s), cam axis means, substrate means, mechanical pieces, an optics lens, a convex or concave lens, lens assembly, telescope means, a film, a display-unit, a transparent material, a translucent material, laser created means, Lenticular means, grating film, hologram means, Lcos means, digital data means, screen-means, display-means, texture piece, injection plastic piece, project means, project device, project assembly, image magnify lens, image magnify means, image create means, tube means, light passing though means, light block out means, optics pieces, diffusion pieces, desire image connect with electric circuit which may has group combination selected from conductive means, wires, light source, circuit means, IC means, timer means, sensor means, blue tooth means, switch means, 2^{nd} or More LED light means for other light functions, remote means, control means, speed control means, printed circuit means, integrated circuit (I.C.) means to make the said the device parts & accessories or light image of the said LED light moving, waving, shaking on desire directions, orientation, position with optional light effects, performance, functions.
The said LED light source not only can offer area illumination functions but also can be has additional more than one functions which may any combination functions selected from night light, project light, accent light, glow characters light, display light, glow parts & accessories, countdown night light, motion sensor light, blue tooth light, remote control light, WiFi light device, internet light device, power fail light, garden light, moving image light, moving parts & accessories light, has other preferred combination of the said prong means, power means, solar power, batteries, adaptor means, receptacle means, energy storage means, transformers, invertors, AC power source, DC power source, or AC & DC both power source, top cover, bottom base, housing means, interchangeable power means, power saving means, cost save means, conductive means, conductive wire, angel adjust means, rotating means, focus adjustable means, motor means, gear set means, magnetic means, magnetic pendent means, or other means so can become a perfect LED light device for Plug-In or desk top or window hanging applications for indoor and outdoor use.
The said project image functions which has the said image being selected from the group consisting of a message, data, a logo, a time, arts, geometric shape(s) and any other image desired to be projected on said desired surface, and said desired surface selected from the group consisting of a ceiling, a wall, a floor, and any other surface which are non-movable; and said image being formed by light from said at least one LED passing thought transparent areas, light block-out means, openings, cut outs, plastic piece with texture, color film, injection piece, Lens assembly, hologram means, laser created means, Lenticular means, grating film, hologram means, Lcos means, digital data means, screen-means, display-means, kaleidoscope-means, kaleidoscope parts & accessories, project-means, magnify means, focus adjust means, more optics means, make the image be more splendid and clear to be seen by viewers of said LED Light device, and the said image being selected from the group consisting of a message, data, a logo, a time, arts, geometric shape(s) and any other image desired to be projected on said desired surface, and said desired surface selected from the group consisting of a ceiling, a wall, a floor, desk top, LED light surface, any other surface; and
At least one power source, circuit means, control means, changing means and trigger means arranged to cause said at least one LED or LEDs to exhibit desired light functions, timing, colors, brightness, illumination, image, and image or moving, waving, shaking, vibration parts & accessories of the said LED light has variety position, orientation, moving, changeable, of the said images or shape or outlooks.
The housing of the said LED light to well arrange all the necessary parts & accessories
The said LED light device may incorporated other added functions may selected from group combination from including speaker, audit device, video device, camera device, recorder device, speaker, sensor means, switch means, remote control device, Bluetooth device, power device, USB charger device, AC outlets power device, digital data storage device, memory card device, memory storage device, energy storage device, batteries, transformer, adaptor, receptacle, outlets, adaptor, receiving device, sound device, speaker, night light device, power fail light device, water lighting device (Water dance, Water wave), Project device, light show device, project means, optics means, optics device, communication device to add top of the current LED light device which has electric coil-means and at least one of magnetic means to show moving, shaking, vibration, waving variable shape, image effects

2. The LED light device has electric coil-means and magnetic-means consist of;
At least one LED supply the light beams to create moving, waving, shaking, variable light's image, or lighted device parts & accessories while connect with its circuit means, IC means, and related electric parts and accessories.
At least one of electric-coil means and magnetic-means to reaction to create move, wave, shake, vibration of the pendants, frame, supports, joints, adjacent piece(s), device's parts & accessories, characters housing, geometric-shape housing, or light source, or image(s) to be moved, waved, shaked with preferred LED light performance to let people seen the variable and moving shapes, light(s), image(s) on desire any non-movable surface(s).
The said LED light device has desired power source combination to supply the device's parts & accessories may select from group combinations from Alternative current, Direct current from wall outlet, extension cord, batteries, energy storage means, solar power, chemical power, water power, wind power, transformer, adaptor, inverter means, or other power generation means though the USB means, prong means, connector means, contact means, conductive means, wire or electric parts or accessories to power the parts & accessories.
The said LED light device is a desk-top or plug-in light or window hang-on device may select from group functions of the following choice desk lamp, night light, USB light, garden light, patio light, table light, accent light, power fail light, remote control light, blue tooth light, security light, door bell light, character light, plant light, solar light, flash light, candle light, projection light, project night light, commercial light, advertisement light, promotion light, or window hang-on light device, or any other

LED light device available from market place.
The said LED light device not only have moving, waving, shaking, vibration function but also has market available LED light functions as above listed to form a more than one functions of said LED light device.

3. The LED Candle light has electric coil-mean and magnetic-means consist of;
At least one of electric coil-means has conductive wire to make a coil to get the magnetic-field while the electric current passing though the copper wire.
At least one or more than one of magnetic-means.
At least one of pendant has the space on the end to install the said at least one or more than one magnetic-means to make the magnetic-means reaction with the said electric coil-means to make the preferred parts or accessories to moving, waving, shaking, vibration and the parts or accessories may selected from any combination from pendant or its related arms, frame, support, joint-piece, connector, adjacent pieces, decorative display, character display, geometric display, project-assembly, optics lens, optics lens assembly, lens, convex lens, magnify lens, image create means, stencil, textures lens, cut-out, windows, openings, silkscreen, transparent areas, translucent areas, block-out piece, injection piece.
The preferred functions of LED light device may including (1) device body, housing has at least one of the parts, body, housing be illuminated or (2) The device has at least one of optics-lens means to project a moving, waving, shaking, vibration LED light image on the non-moving surface (3) The device has more than one functions while optional add other electric function within the said body or housing to become multiple functions.
The said LED Candle light has at least one LED to create the moving flame image on any non-movable surface including Candle light body or wall or ceiling or any other surface for desire size, glow the LED candle body or part of housing be lighted as night light or accent light with designed performance.
The electric coil-means and the said LED light source circuit may incorporate with the desired power source selected in group combination from Alternative or Directive current power source from Wall outlet, extension cord, batteries, electric device, power supplier, transformer, adaptor, inverter, solar power, wind power, water power, chemical power, gas power, air power or any market available power source though prong means, USB wire, USB ports, Quickly connector, receiving means, insert means, battery terminals, contactor, conductive means, wires for desktop or plug-in or hang-in or suction-cup installation for indoor, outdoor, window applications.
The said LED Candle light has its own circuit means, switch means, sensor means, timer means, remote control means, blue tooth means, infra-red means, control means, CDS means, IC means to control the said LED light source or/and electric coil-means to be deliver and not-deliver the electric current under predetermined time, color, brightness, countdown, performance, functions, effects to be seen.

4. The LED light device has electric coil-means and related magnetic means consist of;
At least one LED light source connect with circuit means, power source, IC means and required electric components to make the said LED light source turn on and turn off under predetermined functions, time, brightness, color and performance.
At least one electric coil-means has conductive means coil to create the magnetic field while the electric current input and the magnetic field strength will be changed while input current change value.
at least one of related magnetic-means build-in on movable pendent to get the desire functions in group of combination from
(1) device body, housing has moving, waving, shaking function with at least one of the parts, body, housing be illuminated or
(2) The device has project a moving, waving, shaking, vibration LED light image on the non-moving surface
(3) The device has more than one functions while optional add other electric device function within the said body or housing to become multiple functions LED light device from market available devices
The device may in the form of the toy item, character item, game item, decorative item, gift item, give-away item, commercial items, advertisement items, promotional items, slogan, sign, art related items, child items, or consumer electric products, computer products, communication products or any products available from market place has build-in electric coil-means and related magnetic-means.

5. The desk top device has electric coil-means and related magnetic means consist of;
At least one LED light source connect with circuit means, power source, IC means and required electric components to make the said LED light source turn on and turn off under predetermined functions, time, brightness, color and performance.
At least one electric coil-means has conductive means coil to create the magnetic field while the electric current input and the magnetic field strength will be changed while input current change value.
at least one of related magnetic-means build-in on movable pendent to get the desire functions in group of combination from
(1) Device body, housing or decorative piece has moving, waving, shaking function with at least one of the parts, body, housing be illuminated or
(2) The device has project a moving, waving, shaking, vibration image on the non-moving surface
(3) The device has more than one functions while optional add other electric device function within the said body or housing to become multiple functions LED light device from market available devices

The said Desk Top items is one of the electric device which can install any substrate surface to allow people's eye, nose, mouth, ear, body, skin use including eye can see, mouth can eat, nose can smell, mouth can eat, body can sense, skin can feel for any conventional market electric or electronic devices has build-in LED means.

6. The LED light device has electric coil-means to charge other electric or digital data device(s) consist of;
At least one of the bigger electric-coil on the 1^{st} substrate connect with Alternative power source from wall outlets, extension cord, AC power generator.
At least one of the smaller electric-coil on the 2^{nd} substrate which are separate and district piece with the 1^{st} substrate and the small-coil means accept the 1^{st} Bigger electric-coil magnetic-filed and though the smaller electric-coil to change magnetic-field energy to the electric-power and charge the 2^{nd} substrate of the other electric product's inner rechargeable batteries or Direct current storage means.
At least one of LED as light source to show the charging status on the said 2^{nd} substrate

The improvement including:

The said 1^{st} substrate is inside or the said Desk Top items which The said Desk Top items is one of the electric device which can install any substrate surface to allow people's eye, nose, mouth, ear, body, skin use including eye can see, mouth can eat, nose can smell, mouth can eat, body can sense, skin can feel for any conventional market electric or electronic devices has build-in LED means.

And

At least 2nd of LED light to supply the desk top items has 2^{nd} light effects for desired combination select from illumination, signal, message, time, weather station, brightness, color to be seen.

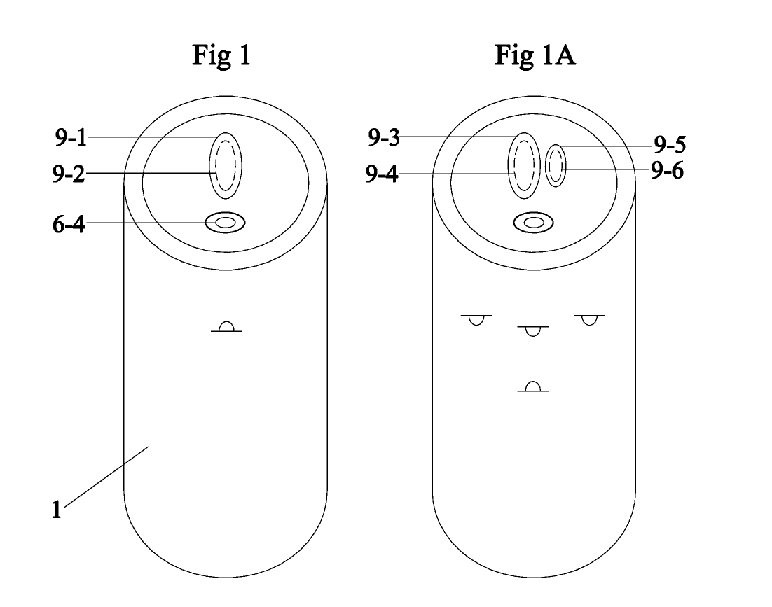

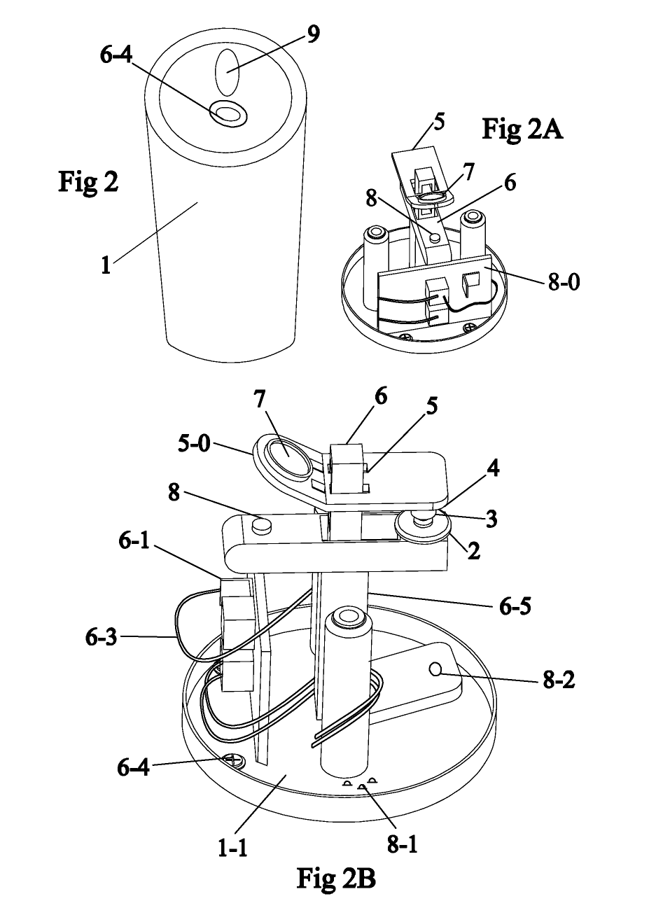

FIGS. 1 and 1A show the LED light device (1) has the moving, waving, swing, shaking, vibration LED light source image in a flame look (9-1) (9-2) (9-3) (9-4). The flame look image are project from inside LED light source (Shown on FIG. 1-1 and FIG. 1-2) though the opening (6-4) and moving optic-lens install on the moving pendent which cause flame image moving as candle in the wind effects look real but without any danger for people to install on the window, desk top, plug-in on wall outlets by different power source. The said moving optics-lens install on the moving pendent so the light beam pass into the optics lens has different input angle, input light beam also make the flame image become bigger size (9-1) and small size (9-2) and location and orientation also different. To make the flame image project on the non-movable surface including the device's space or wall or ceiling depend on the relation of the LED light source position and optics-lens relative position to make decision where will show the flame image. It also has relation with opening, cut-out, window (not open hole) so can make the projection image show on desire position, orientation, surface which are non-movable.

FIG. 1A shows that the LED light device has more than one LED light source which can make the at least part of the device body, housing, parts to be illuminated to make the whole piece look better under the dark environment. This application is more better to apply the kids and child products including toy item, character item, game item, decorative item, gift item, and the give-away item, commercial items, advertisement items, promotional items, slogan, sign, art related items, child items, or consumer electric products, computer products, communication products or any products available from market place. These applications has the moving, waving, shaking, vibration features to see the character, toy, display unit, commercial sign more easily to catch people eyes and attention to own the said LED light.

FIGS. 2, 2A, and 2B show the LED light device body (1) has opening (6-4) to allow innder LED light source project flame like image (9) on the non-movable surface which is the body of the said LED light device (1). It also can project to the surrounding wall, ceiling, background while make some adjustable of the Opening (6-4), inner LED light source (Not shown), inner moving pendent and its build-in Optics-leans so can get the image project to any desired location, place, surface as all co-pending and co-inventor plurality of U.S. patent pending, filing cases. It is appreciated all the co-inventor and co-pending related to the project LED light, LED light, LED night light all prior claims and disclosure still fall within the current invention as coverage without any limitation as the current invention are continuous or continuously-In-Part filing of variety co-inventor's filing or issues or pending cases.

From FIG. 2 shown the Body (1) also can glow the body by inner more than one LED light source which may install the more than one LEDs on top of inner surface so the light beam will spread out and not show the inner parts shadows. Or alternative method to make the inner surface body with some diffusion optics treatment so the light will become very average spread to all body to get very good photometric arrangement. It also can use the seal-means to seal the high brightness spot of LED light source all light beam within the seal-means so the light come out very even on any point, sides. These equivalent or alternative method is appreciated still fall within the current invention scope.

FIGS. 2A and 2B show the construction of the current invention for electric coil-means and related at least one of the magnetic-means and moving pendent relation. The said movable pendent (5) with build-in optic-lens (7) and has magnetic-means (3) install on the end of the said Pendent (5) so can has reaction with the electric coil-means (2) to make the moving of the pendent (5) while change the electric current amount into the said electric coil-means (2) which are install on desire location inside of the said LED light device housing. The said LED light source (8) install on the inside of housing and has proper distance and location and orientation for the optics-means (7) which are install on the moving pendent (5). While the pendent magnetic-means reactivated by electric coil-means's magnetic-field force, then the pending (5) will moving, so the optic-lens (7) moving accordingly to make the LED light source (8) light beam passing though the said Optics-lens (7) has the variable image happened and passing though the housing opening (6-4) or cut-out or windows to shown to be seen by viewer.

FIG. 2B, one can also see the pendent related parts including the holder (4), frame (6), connector or quickly means (6-1), arms, supports, connector(s), joint-piece, holder(s), cam axis means, substrate means, mechanical pieces and the electric current delivery means including LED (8), circuit with all related parts & accessories (8-0), More than one LED (8-1), Switch or sensor or control means (8-3) so can make the said LED or LEDs turn on and turn off under desired functions, performance, effects. The circuit means as below discuss has all parts & accessories selected from market available type so can have at least on LED has light functions and may selected more than one functions from variety of the electric components assembly to get power fail, timer, countdown time, motion sensor, blue tooth operation, wireless control, remote control, infra-red control, or smoke detector, flood detector, build-in whistle means, build-in added electric functions available from market place as long as the said LED light device has (1) Moving, waving, shaking, motion, vibration functions for light image or device parts movement (2) The device has LED light means (3) The device has added more than one of function (4) device has build-in electric coil-means and related magnetic-means with pendent and related parts, or any combination from the Number (1) (2) (4) with optional of Number (3) features.

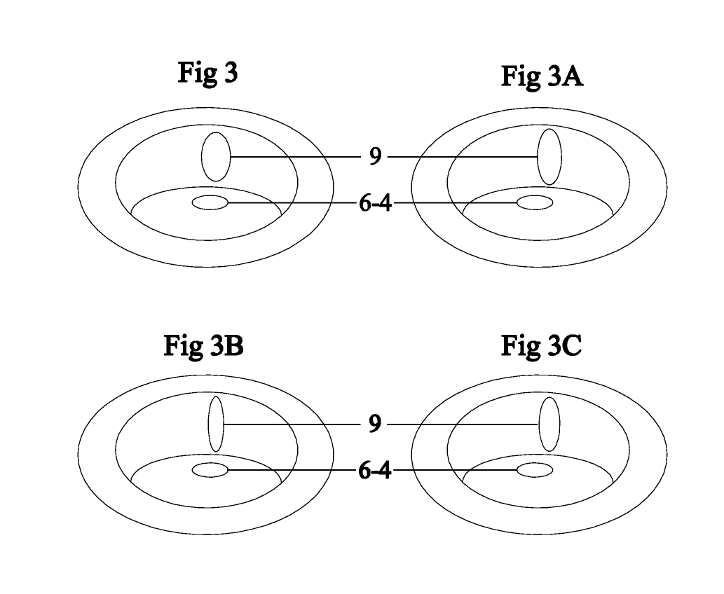

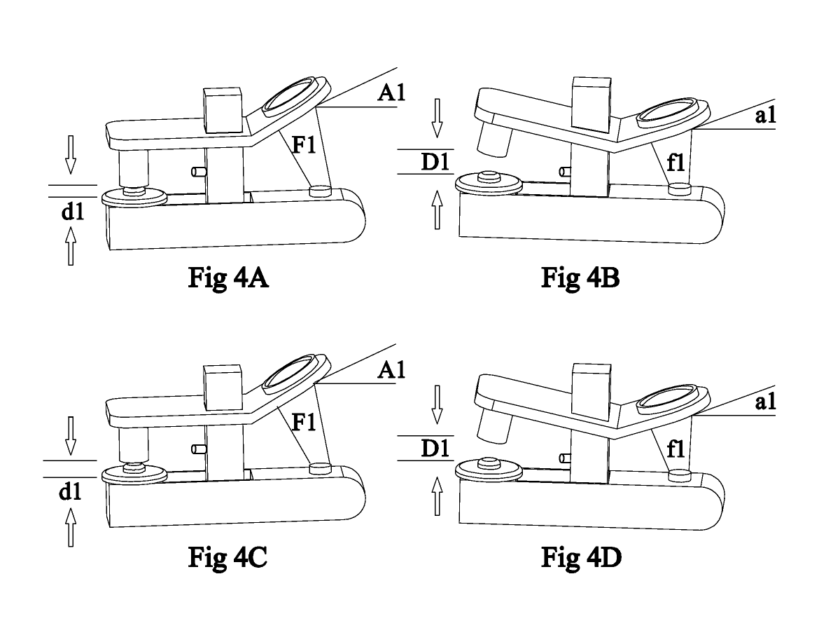

FIGS. 3 and 3A-3C show the Flame image of preferred embodiment project though the opening (6-4) to LED candle body with moving flame image has different size, brightness, position, color, orientation, angle. The flame image project to the device non-movable body, It also can project to anywhere as above and following discussion. FIGS. 4A-4D show the relation of the

(1) LED light source (8) to Optic-lens (7) marked by f1, f2, F1, F2

(2) moving pending (5) related to the electric coil-means (2) to its magnetic means (3) indicated by d1, d2, D1, D2

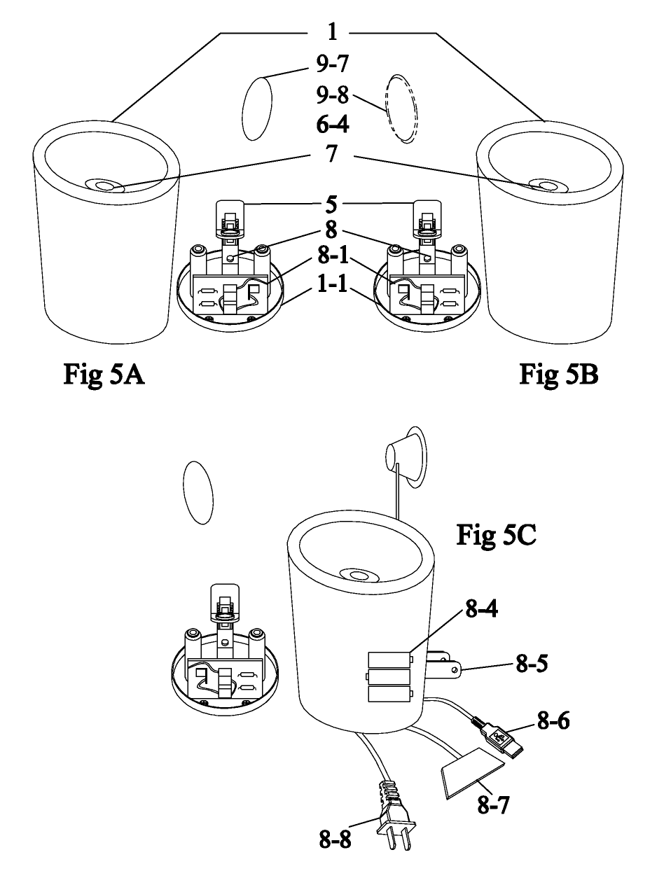

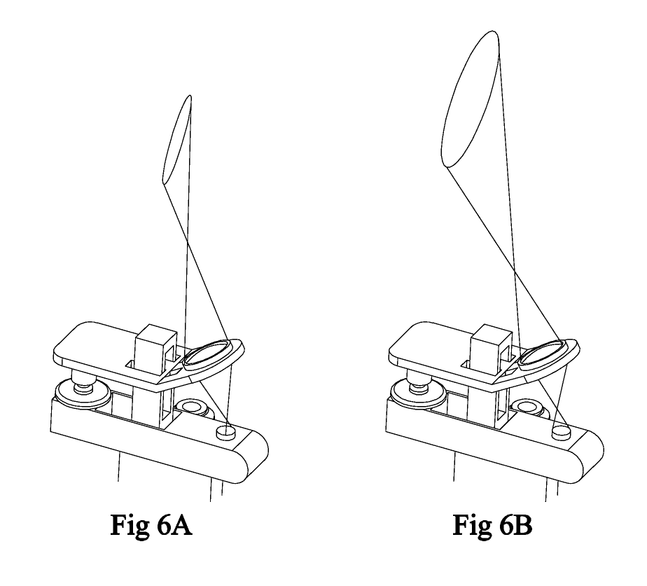

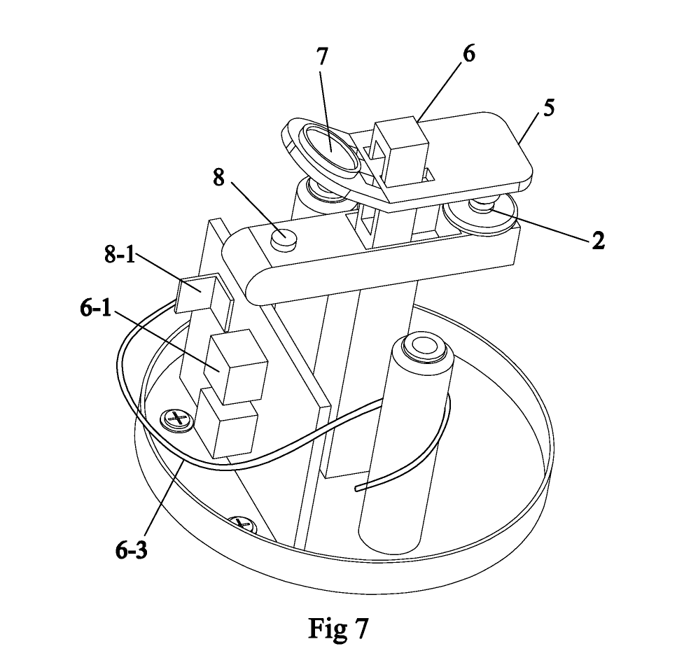

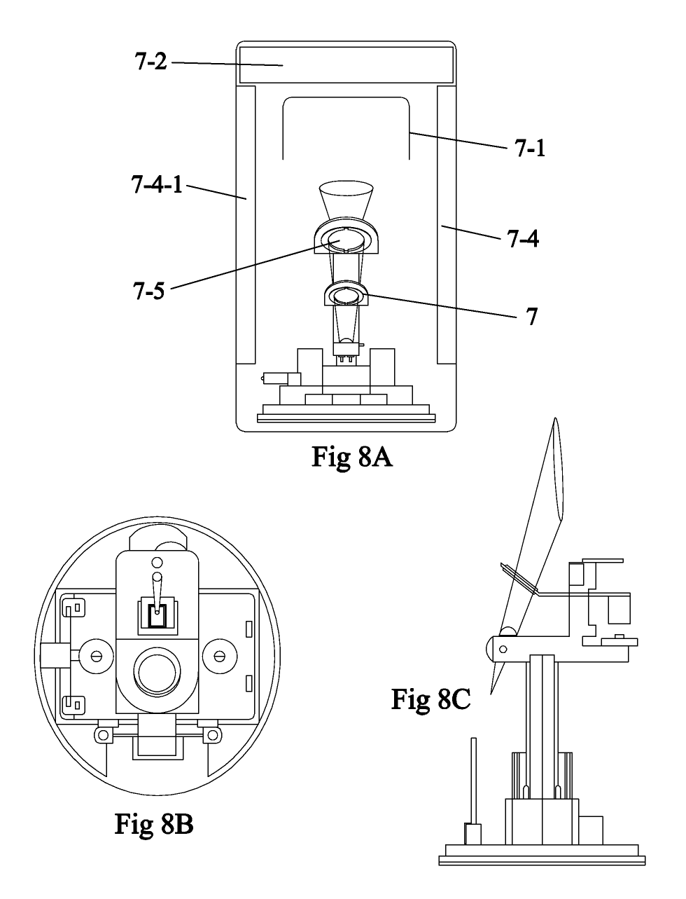

(3) The moving pendent (5) related to horizon Line marked by a1, a2, A1, A2
So can easily know the relation for the LED light source (8) to emit light beam into the moving pendent (5) has f1, f2, F1, F2 distance and the optics-lens (7) change relative position while moving pendent (5) has the relative position to horizon line as a1, a2, A1, A2 so the optic-lens will close to or away to the said LED light source (8). Also the pendent (5) will has different distance to the electric coil-means while the current been changed so will have d1, d2, D1, D2 distance to make the said pendent (5) and optics-lens (7) changed position related to the LED light source (5). These chain connection for the pendent (5) and Optic-lens (7) and Magnetic means (3) and electric coil-means (2) to make the LED light beam input to optics-lens (7) changed to make the project image also changed on size, position, brightness, orientation, color, . . . etc. The project image can project any where of non-movable surface.
FIGS. 5A and 5B show the different LED light image as flame look like (9-7) and (9-8) which made out from same current invention of preferred 1^{st} embodiment so can see how it size for inner construction and outside body and related image change on size, position, orientation, color, brightness.
FIG. 5C shows the different application and different conductive means to connect with different power source as above and following listed details for the conductive means and the said power source and the applications. It also same as the claims parts.
FIGS. 6A and 6B show the physics theory how to come out the project image (9) though at least one of the optics-means (7) build-in on the said moving pendent (5). This preferred embodiment use the convex lens so the LED light beam passing though the lens surface and passing though the lens thickness to make the image as physics theory. The reason why the image on the wall not on the ceiling basing on the LED light source (8) and position of the optics-lens which are tilt so allow the direct light beams to make the image on the desire wall, Not ceiling. If need to make image project to other surface can just make proper arrangement for the LED light source, optics-lens, pendent, opening, cut-out, windows so can make preferred project image. As the co-inventor U.S. Pat. No. 13/549,728 has all the details description for this optics.
FIGS. 7A and 8A-8C show on the details construction of the said 1^{st} embodiments. All details shown on the fig so do not discuss here for more details.
FIGS. 9A-9C show the 2^{nd} embodiment which has the cosmetic or display-unit added on the inner moving pendent and its related arms, supports, frames, joint means, connection means, crane means, sharp tip means, screw means (6-1) (6-2) (6-3) (6-4) (6-5) to make the display-unit (here as a character's person) has head, arms moving, waving, shaking, vibration basing on the reaction of the said electric coil-means (2) and magnetic-means (3). Further, the character display-unit glow whole body by the more than one LED light means (8-1). So this is typical as Claim stated the (1) LED light device not only has at least one part of the body or housing can be moving, waving, shaking, vibration (2) Apply more than one LED light means to make the LED image project to desired non-movable surface or make the device body or housing or at least one part or areas be lighted. From FIG. (9-1) can see display-unit has head on the center and two arms on horizon while the switch to HOLD pendent not to move, While the STOP means to released and electric coil-means and magnetic means activated by each other, then the display unit (Here as Character) will be head shaking, arms waving to make very motional function to see the eye-catching functions, effects with optional LED light to project image or glow the at least part of the device with good light effects so can let people can see during night time or even in the dark environment. Further more can add the 30 minutes timer countdown to shut the Glow light after switch to turn on. Or adding the music, sound, melody to help kids to fall asleep or add the alarm clock to let this device has more functions to become value products to buy one current invention products has more than one or more than (N-number) function in one unit. This is current invention's claim parts stated may optional add the additional functions and those functions selected from group combination from all kind of electric functions available from market place including to let people eye, nose, mouth, ear, body, skin can see, can hear, can smell, can eat, can feel, can touched functions all belong to the said added electric functions top of the (1) Movable device has build-in electric coil-means and magnetic-means (2) has at least one of LED light source to project moving image or glow the device at least part of body or housing . . . . This is what the current invention claim and features.
FIGS. 9D-9F show the relation for the electric coil-means and magnetic-means for 2^{nd} embodiment which same as the FIGS. 4A-4D so and all details description with brief points shown on the FIGS. 9D-9F so do not discuss more details here.
FIGS. 10A-10C show the moving pendent (5) and its frame (6-1), support (5-2), arms, bars, extend piece, joint-means (5-3), joint head means (5-6), connect means, fasten means, extend frame and the tip for waging means for 2 arms (5-4) and tip for waving means for head (5-7) to understand how to make all construction with more than one of the parts be moving, waving, shaking, vibration by the all these means joint one by one and has the sharp tip (5-7) (5-4) to make the display-unit(s) with most less friction force while make the moving, waving, shaking, vibration by magnetic field force created by the electric coil-means and its related magnetic-means.
FIGS. 11A and 11B show the 3^{rd} embodiment which is plants inside vase which are the same as the FIG. (9-1) (9-2) (9-3) for Character display-unit.
FIGS. 12A-12C show the 3^{rd} embodiment which all the moving pendent and its parts & accessories how to joint together as the FIGS. 10A-10C, the only difference is the said Plant inside vase has 2 leaves and 1 flower so it has more than one of related magnetic-means to work with the one electric coil-means so can make more than two of the said display-units to move which are more than 1^{st} embodiment for 1 moving piece and more than 2^{nd} embodiment for 2 moving parts of LED device. The 3^{rd} embodiment shown the related parts & accessories to shown how to make all more than 2 parts moving connection and joint-means and more than one of magnetic means built-in more than one moving pendent to drive 3 parts to moving.
FIGS. 13A-13C show the arrangement for 3 parts moving construction. Also, shown the more than one of moving pendants has built-in magnetic means so can drive 3 parts to moving together, Two parts of the leaves are waving and Flower are shaking so can make very good eye-catching motion effects and use the preferred power source selected from any kind from market available source which has above and following discussion details. The plant inside vase for 3^{rd} embodiment also has (1) built-in electric coil means and at least one magnetic means to active to created magnetic field strength to make at least two moving pendent to moving, waiving, shaking, vibration (2) At least have one or more LED light source to make the project image or make the at least part of device be illuminated as above or follow detailed discussion and claim coverage.
The current invention to project Image basing on co-inventor's co-pending or co-issued patents including (1) More than one LEDs (2) more than one optics-means (3) Interchangeable power source (4) as inventor's all prior patents and co-pending all LED project light concept as above and below listed (9) co-pending and issued Prior arts.

Ser. No. 12/318,471, U.S. Ser. No. 12/318,470, U.S. Ser. No. 12/834,435 and also is continuous filing for co-inventor's prior filing cases as below issued patents:

U.S. Ser. No. 12/292,153 (now is U.S. Pat. No. 7,871,192),

U.S. Ser. No. 12/232,505 (now is U.S. Pat. No. 7,832,917),

U.S. Ser. No. 12/318,473 (now is U.S. Pat. No. 7,832,918).LED light has laser means

U.S. Ser. No. 12/624,621 (Now is U.S. Pat. No. 8,303,150) LED project light for Seasonal items

U.S. Ser. No. 12/771,003 (now is U.S. Pat. No. 8,408,736) Light device has More than one project means.

U.S. Ser. No. 12/876,507 (now U.S. Pat. No. 8,083,377) Light device has projection function with focus adjustable and project means can change position

U.S. Ser. No. 12/886,832 Digital data projection Light device, Sep. 8, 2010 filed

U.S. Ser. No 12/938,564 Laser projection light device, Nov. 4, 2010 filed

U.S. Ser. No. 12/948,953 LED light has time projection. Nov. 13, 2010 filed.

U.S. Ser. No. 13/021,107 LED light has 3Dimensional projection, Feb. 4, 2011 filed.

Above listed Projection light device total has (9) projection light device are parent filing cases as CIP filing of the current invention.

Although specific preferred embodiments of the current invention are described above, it is to be appreciated that all alternative, equivalent, same-function and/or same-skill-or-theory variations, modifications, replacements, arrangements, or constructions may still fall within the current scope of the invention.

1. An LED light device has coil-means and magnetic-means comprising:
At least one LED arranged as a light source to supply visible light beams;
At least one of the electric coil-means which will create the magnetic-field while electric current passing though the coil's conductive wire,
At least one or more than one of the magnetic-means has desire combination from group combination select from magnetic(s), electric coil(s), magnetic activated-means(s), pendant-mean, frame(s), arms, supports, connector(s), joint-piece, holder(s), cam axis means, substrate means, mechanical pieces, an optics lens, a convex or concave lens, lens assembly, telescope means, a film, a display-unit, a transparent material, a translucent material, laser created means, Lenticular means, grating film, hologram means, Lcos means, digital data means, screen-means, display-means, texture piece, injection plastic piece, project means, project device, project assembly, image magnify lens, image magnify means, image create means, tube means, light passing though means, light block out means, optics pieces, diffusion pieces, desire image connect with electric circuit which may has group combination selected from conductive means, wires, light source, circuit means, IC means, timer means, sensor means, blue tooth means, switch means, 2^{nd} or More LED light means for other light functions, remote means, control means, speed control means, printed circuit means, integrated circuit (I.C.) means to make the said the device parts & accessories or light image of the said LED light moving, waving, shaking on desire directions, orientation, position with optional light effects, performance, functions,
The said LED light source not only can offer area illumination functions but also can be has additional more than one functions which may any combination functions selected from night light, project light, accent light, glow characters light, display light, glow parts & accessories, countdown night light, motion sensor light, blue tooth light, remote control light, WiFi light device, internet light device, power fail light, garden light, moving image light, moving parts & accessories light, has other preferred combination of the said prong means, power means, solar power, batteries, adaptor means, receptacle means, energy storage means, transformers, invertors, AC power source, DC power source, or AC & DC both power source, top cover, bottom base, housing means, interchangeable power means, power saving means, cost save means, conductive means, conductive wire, angel adjust means, rotating means, focus adjustable means, motor means, gear set means, magnetic means, magnetic pendent means, or other means so can become a perfect LED light device for Plug-In or desk top or window hanging applications for indoor and outdoor use,
The said project image functions which has the said image being selected from the group consisting of a message, data, a logo, a time, arts, geometric shape(s) and any other image desired to be projected on said desired surface, and said desired surface selected from the group consisting of a ceiling, a wall, a floor, and any other surface which are non-movable; and said image being formed by light from said at least one LED passing thought transparent areas, light block-out means, openings, cut outs, plastic piece with texture, color film, injection piece, Lens assembly, hologram means, laser created means, Lenticular means, grating film, hologram means, Lcos means, digital data means, screen-means, display-means, kaleidoscope-means, kaleidoscope parts & accessories, project-means, magnify means, focus adjust means, more optics means, make the image be more splendid and clear to be seen by viewers of said LED Light device, and the said image being selected from the group consisting of a message, data, a logo, a time, arts, geometric shape(s) and any other image desired to be projected on said desired surface, and said desired surface selected from the group consisting of a ceiling, a wall, a floor, desk top, LED light surface, any other surface; and
At least one power source, circuit means, control means, changing means and trigger means arranged to cause said at least one LED or LEDs to exhibit desired light functions, timing, colors, brightness, illumination, image, and image or moving, waving, shaking, vibration parts & accessories of the said LED light has variety position, orientation, moving, changeable, of the said images or shape or outlooks,
The housing of the said LED light to well arrange all the necessary parts & accessories
The said LED light device may incorporated other added functions may selected from group combination from including speaker, audit device, video device, camera device, recorder device, speaker, sensor means, switch means, remote control device, Bluetooth device, power device, USB charger device, AC outlets power device, digital data storage device, memory card device, memory storage device, energy storage device, batteries, transformer, adaptor, receptacle, outlets, adaptor, receiving device, sound device, speaker, night light device, power fail light device, water lighting device (Water dance, Water wave), Project device, light show device, project means, optics means, optics device, communication device to add top of the current LED light device which has electric coil-means and at least one of magnetic means to show moving, shaking, vibration, waving variable shape, image effects

2. The LED light device has electric coil-means and magnetic-means consist of;
At least one LED supply the light beams to create moving, waving, shaking, variable light's image, or lighted device parts & accessories while connect with its circuit means, IC means, and related electric parts and accessories,
At least one of electric-coil means and magnetic-means to reaction to create move, wave, shake, vibration of the pendants, frame, supports, joints, adjacent piece(s), device's parts & accessories, characters housing, geometric-shape housing, or light source, or image(s) to be moved, waved, shaked with preferred LED light performance to let people seen the variable and moving shapes, light(s), image(s) on desire any non-movable surface(s),
The said LED light device has desired power source combination to supply the device's parts & accessories may select from group combinations from Alternative current, Direct current from wall outlet, extension cord, batteries, energy storage means, solar power, chemical power, water power, wind power, transformer, adaptor, inverter means, or other power generation means though the USB means, prong means, connector means, contact means, conductive means, wire or electric parts or accessories to power the parts & accessories,
The said LED light device is a desk-top or plug-in light or window hang-on device may select from group functions of the following choice desk lamp, night light, USB light, garden light, patio light, table light, accent light, power fail light, remote control light, blue tooth light, security light, door bell light, character light, plant light, solar light, flash light, candle light, projection light, project night light, commercial light, advertisement light, promotion light, or window hang-on light device, or any other LED light device available from market place,
The said LED light device not only have moving, waving, shaking, vibration function but also has market available LED light functions as above listed to form a more than one functions of said LED light device.

3. The LED Candle light has electric coil-mean and magnetic-means consist of;
At least one of electric coil-means has conductive wire to make a coil to get the magnetic-field while the electric current passing though the copper wire,
At least one or more than one of magnetic-means,
At least one of pendant has the space on the end to install the said at least one or more than one magnetic-means to make the magnetic-means reaction with the said electric coil-means to make the preferred parts or accessories to moving, waving, shaking, vibration and the parts or accessories may selected from any combination from pendant or its related arms, frame, support, joint-piece, connector, adjacent pieces, decorative display, character display, geometric display, project-assembly, optics lens, optics lens assembly, lens, convex lens, magnify lens, image create means, stencil, textures lens, cut-out, windows, openings, silkscreen, transparent areas, translucent areas, block-out piece, injection piece,
The preferred functions of LED light device may including (1) device body, housing has at least one of the parts, body, housing be illuminated or (2) The device has at least one of optics-lens means to project a moving, waving, shaking, vibration LED light image on the non-moving surface (3) The device has more than one functions while optional add other electric function within the said body or housing to become multiple functions,
The said LED Candle light has at least one LED to create the moving flame image on any non-movable surface including Candle light body or wall or ceiling or any other surface for desire size, glow the LED candle body or part of housing be lighted as night light or accent light with designed performance,
The electric coil-means and the said LED light source circuit may incorporate with the desired power source selected in group combination from Alternative or Directive current power source from Wall outlet, extension cord, batteries, electric device, power supplier, transformer, adaptor, inverter, solar power, wind power, water power, chemical power, gas power, air power or any market available power source though prong means, USB wire, USB ports, Quickly connector, receiving means, insert means, battery terminals, contactor, conductive means, wires for desktop or plug-in or hang-in or suction-cup installation for indoor, outdoor, window applications,
The said LED Candle light has its own circuit means, switch means, sensor means, timer means, remote control means, blue tooth means, infra-red means, control means, CDS means, IC means to control the said LED light source or/and electric coil-means to be deliver and not-deliver the electric current under predetermined time, color, brightness, countdown, performance, functions, effects to be seen.

4. The LED light device has electric coil-means and related magnetic means consist of;
At least one LED light source connect with circuit means, power source, IC means and required electric components to make the said LED light source turn on and turn off under predetermined functions, time, brightness, color and performance,
At least one electric coil-means has conductive means coil to create the magnetic field while the electric current input and the magnetic field strength will be changed while input current change value,
at least one of related magnetic-means build-in on movable pendent to get the desire functions in group of combination from
(1) device body, housing has moving, waving, shaking function with at least one of the parts, body, housing be illuminated or
(2) The device has project a moving, waving, shaking, vibration LED light image on the non-moving surface
(3) The device has more than one functions while optional add other electric device function within the said body or housing to become multiple functions LED light device from market available devices
The device may in the form of the toy item, character item, game item, decorative item, gift item, give-away item, commercial items, advertisement items, promotional items, slogan, sign, art related items, child items, or consumer electric products, computer products, communication products or any products available from market place has build-in electric coil-means and related magnetic-means.

5. The desk top device has electric coil-means and related magnetic means consist of;
At least one LED light source connect with circuit means, power source, IC means and required electric components to make the said LED light source turn on and turn off under predetermined functions, time, brightness, color and performance,
At least one electric coil-means has conductive means coil to create the magnetic field while the electric current input and the magnetic field strength will be changed while input current change value,
at least one of related magnetic-means build-in on movable pendent to get the desire functions in group of combination from
(1) Device body, housing or decorative piece has moving, waving, shaking function with at least one of the parts, body, housing be illuminated or
(2) The device has project a moving, waving, shaking, vibration image on the non-moving surface
(3) The device has more than one functions while optional add other electric device function within the said body or housing to become multiple functions LED light device from market available devices
The said Desk Top items is one of the electric device which can install any substrate surface to allow people's eye, nose, mouth, ear, body, skin use including eye can see, mouth can eat, nose can smell, mouth can eat, body can sense, skin can feel for any conventional market electric or electronic devices has build-in LED means.

6. The LED light device has electric coil-means to charge other electric or digital data device(s) consist of;
At least one of the bigger electric-coil on the 1^{st} substrate connect with Alternative power source from wall outlets, extension cord, AC power generator,
At least one of the smaller electric-coil on the 2^{nd} substrate which are separate and district piece with the 1^{st} substrate and the small-coil means accept the 1^{st} Bigger electric-coil magnetic-filed and though the smaller electric-coil to change magnetic-field energy to the electric-power and charge the 2^{nd} substrate of the other electric product's inner rechargeable batteries or Direct current storage means,
At least one of LED as light source to show the charging status on the said 2^{nd} substrate
The improvement including:
The said 1^{st} substrate is inside or the said Desk Top items which The said Desk Top items is one of the electric device which can install any substrate surface to allow people's eye, nose, mouth, ear, body, skin use including eye can see, mouth can eat, nose can smell, mouth can eat, body can sense, skin can feel for any conventional market electric or electronic devices has build-in LED means,
And
At least 2nd of LED light to supply the desk top items has 2^{nd} light effects for desired combination select from illumination, signal, message, time, weather station, brightness, color to be seen.
